(19) United States
(12) Patent Application Publication
(10) Pub. No.: US 2009/0320320 A1
(43) Pub. Date: Dec. 31, 2009

(54) METHOD OF DRYING CLOTHING BY REDUCING HEAT AT END OF DRYING CYCLE

(75) Inventor: Dennis Slutsky, Providence, RI (US)

Correspondence Address: WOLF GREENFIELD & SACKS, P.C., 600 ATLANTIC AVENUE, BOSTON, MA, 02210-2206, US

(73) Assignee: American Dryer Corp., Fall river, MA (US)

(21) Appl. No.: 12/556,749

(22) Filed: Sep. 10, 2009

Related U.S. Application Data
(63) Continuation of application No. 11/754,398, filed on May 29, 2007.
(60) Provisional application No. 60/804,262, filed on Jun. 8, 2006.

(51) Int. Cl. F26B 3/02

(52) U.S. Cl. 34/495

(57) ABSTRACT

The present invention is a method of drying clothing. The method of drying clothing involves providing a dryer, preferably a coin-operated clothes dryer. The dryer contains a heat source in thermal communication with the dryer. Next, a user inserts clothes into the dryer and initiates a drying cycle to reduce the overall moisture within the clothes. To initiate a drying cycle, the user purchases a predetermined period of time that is at least one block of time. The dryer is turned on and the heat source is then operated at a first drying temperature, preferably 160.degree. F., while a sensor detects the level of moisture within the clothes. Once the level of moisture within the clothes is below a predetermined level, the heat source is lowered to a second operating temperature, preferably 100.degree. F. This method of reducing heat conserves energy to operate the dryer and helps avoid over-drying of clothes.

### CROSS REFERENCE TO RELATED APPLICATION

This application is a continuation of U.S. application Ser. No. 11/754,398, filed May 29, 2007, entitled “Method Of Drying Clothing By Reducing Heat At End Of Drying Cycle”, which application claims priority from earlier filed provisional patent application Ser. No. 60/804,262, filed Jun. 8, 2006 and both are hereby incorporated by reference herein in their entirety.

### BACKGROUND OF THE INVENTION

The present invention generally relates to drying clothing and a method of drying clothing using a dryer. More specifically, the present invention relates to a method of operating a coin-operated clothes dryer. The present invention further relates to a method of making such coin-operated clothes dryers more efficient in operation.

In the prior art, clothes dryers are very well known in the art. In particular, coin-operated clothes dryers are commonly used so that a person can use the dryer as needed to obviate the need to own one.

Coin operated clothes dryers are typically located in a “laundromat” or other similar locations. For use by many customers at the same time, these locations typically house several coin-operated dryer machines, which are typically powered by gas or other fuels. There is a concern associated with operating a laundry facility as to the continuing cost of operation of the equipment, including dryers. There is a desire to operate coin-operated dryer machines in a more cost-effective manner by reducing energy consumption. There is a specific need to avoid superfluous drying of clothes to save energy.

In the prior art it is well known that a typical coin-operated dryer is operated by paying for a block of drying time. For example, a quarter is inserted into the dryer for 15 minutes of drying time. At the end of the time period, the dryer shuts down and the clothes are removed by the user. At the end of the time period, the drying condition of the clothes is either 1) just right; 2) too wet; or 3) over-dried. If the clothes are dried just right at the end of the period, the dryer has operated in an efficient manner in that just enough energy was used to dry the clothes properly.

However, in practice, this is not usually the case. It is common that the clothes are still too wet after the purchased time period has expired. At that point, the user buys an additional block of drying time, which is commonly 15 minutes. It is very common that the clothes are dried “just right” with additional time remaining on the purchased amount. This additional time is not needed for drying the clothes which expends extra energy and cost for the drying operation. Moreover, the over-drying of clothes not only unnecessarily adds cost to operation of the dryer for unneeded dry time but also can damage the clothes.

This problem is exacerbated in the common situation of where a user buys much more time than is needed to ensure that when they return to the coin-operated laundry facility, their clothes will not be wet and in need of further is drying. In this scenario, over-dried clothes are an accepted drawback that is outweighed by not having to buy additional dry time requiring further wait time for the user. Also, users commonly over-dry their clothes to use up all of the dry time that they have purchased to get “their money's worth”.

In view of the foregoing, over-drying of clothes is extremely common in a coin-operated dryer where excess energy is used thereby raising the overall cost of operation of the dryer. Thus, there is a desire to avoid over-drying of clothes. There is a further need to reduce the energy cost associated with operating a laundry facility. Therefore, there is a desire to deliver the ability to dry clothes in a coin-operated dryer to a proper dried condition to the consumer while consuming less energy.

### SUMMARY OF THE INVENTION

The present invention preserves the advantages of prior art methods for drying clothes. In addition, it provides new advantages not found in currently available methods for drying clothes and overcomes many disadvantages of such currently available methods for drying clothes.

The invention is generally directed to a method drying clothing containing the following steps. First, a user selects a dryer for operation, preferably a coin-operated clothes dryer. The clothes dryer provides a heat source in thermal communication with the dryer. Next, a user inserts clothes into the dryer and initiates a drying cycle to reduce the overall moisture within the clothes. To initiate a drying cycle, a user purchases a predetermined period of time in at least one block of time.

After initiation of the drying cycle, the heat source operates at a first drying temperature, preferably 160.degree. F., to reduce the moisture level of the clothes while maintaining the integrity of the clothes. Meanwhile, a sensor positioned within the dryer detects the level of moisture in the clothes. If the level of moisture in the clothing is above a predetermined level, the temperature of the heat source maintains at a first drying temperature. If the level of moisture in the clothing is below a predetermined level, the temperature of the heat source lowers to a second drying temperature, preferably 100.degree. F. By reducing the temperature to a second drying temperature, the overall cost to operate the dryer is reduced while preventing the clothes from being over-dried.

Once the predetermined period of time has elapsed, the drying cycle terminates resulting in the turning off of the heat source and the dryer.

It is therefore an object of the embodiment to provide a method of drying clothing that reduces the temperature of the heat source within a clothes dryer at the end of a drying cycle.

It is a further object of the embodiment to provide a method of drying clothing that prevents clothes from being over-dried during the drying cycle of a clothes dryer.

Another object of the embodiment is to provide a method of drying clothing that reduces the overall cost of operation of a coin-operated clothes dryer.

### BRIEF DESCRIPTION OF THE DRAWINGS

The novel features which are characteristic of the method of drying clothing are set forth in the appended claims. However, the method of drying clothing, together with further embodiments and attendant advantages, will be best understood by reference to the following detailed description taken in connection with the accompanying drawings in which:

FIG. 1 is a perspective view of a coin-operated dryer as used in the prior art;

FIG. 2 is block diagram showing the interaction of component parts in accordance with the present invention; and

FIG. 3 is a flow chart for the method of the present invention for drying clothing by reducing heat at the end of a drying cycle.

### DETAILED DESCRIPTION OF THE PREFERRED EMBODIMENTS

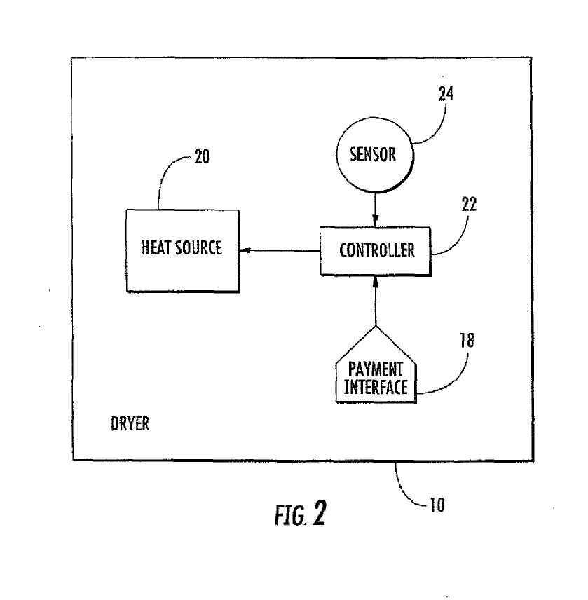

The present invention solves the problems associated with prior art methods of drying clothes and, in particular, drying clothes using a dryer. It reduces the overall energy cost of operating the dryer while providing the same end result, namely, providing fully dried clothes to the user. As shown in FIG. 2, the method provides a new and novel method for drying clothing by reducing the level of heat at the end of the drying cycle if the clothing has been fully dried.

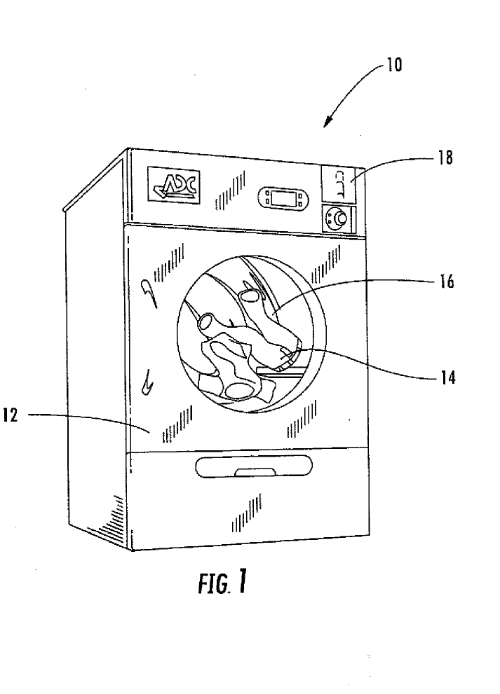

In accordance with the method for drying clothes, a coin-operating clothes dryer 10 of the type shown in FIG. 1 is provided. The dryer in FIG. 1 is merely an example and any other coin-operated clothes dryer 10 may be used that is capable of drying clothes for a predetermined period of time. The dryer 10 includes a door 12 into which clothes 14 can be loaded into a basket 16. Drying time is purchased by inserting coins (not shown) into a payment interface 18, such as coin counting device. The operating of such a coin operated dryer is so well known in the art that further discussion is not needed herein.

As schematically depicted in FIG. 2, the dryer 10 includes a heat source 20 in thermal connection with the basket 16 of the dryer 10. As can be seen, a controller 22 is employed to control the operation of the delivery of heat within the dryer among other functionality of the dryer, such as rotation of basket 16. The controller 22 can be any type of mechanically or electrical device that can control the functionality of the dryer 10 described herein. Preferably, the controller 22 is a processor located on a circuit board within the dryer 10 with the appropriate software therein. As is well known in the art, such a controller can be programmed in any suitable way to carry out the method of the present invention whereby the temperature of the heat source is lowered for the balance of time of the drying cycle after a certain level of moisture is met.

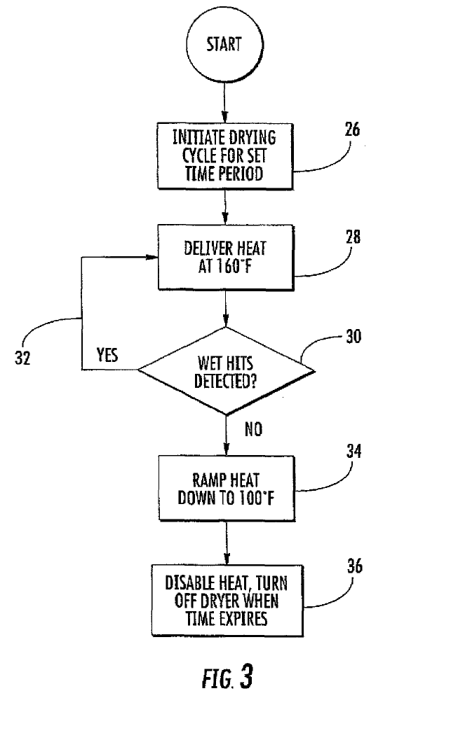

Still referring to FIG. 2, the payment interface 18 is in electrical communication with the controller 22 to provide information as to the number of blocks of time, and as a result the total drying time, purchased by the user. A moisture sensor 24 is also provided, the output of which is in electrical communication with the controller 22 to provide information relating to the wetness of the clothes being dried. The present invention is unique in that additional functionality of controller 22 is provided to reduce the temperature of the heat source when desired, namely when the clothes reach a predetermined amount of dryness. This functionality is employed to control the heat delivery, as will be described in detail below in connection with FIG. 3.

Now referring to FIG. 3, the user inserts clothes 14 into the dryer 10 and a drying cycle is initiated at 26 for a predetermined time. To initiate the drying cycle, the user inserts payment for a block of time or a number of blocks of time. For example, the user may insert three quarters to accumulate three blocks of 15 minutes for a total of 45 minutes of drying time into the payment interface 18. Alternatively, an on/off switch (now shown) may be used in a non-coin operated dryer, which when moved to the “on” position, initiates the drying cycle.

Once at least one block of time is purchased, the dryer 10 is turned on, the heating source 20, such as a burner, is fired, and the drying begins at a first drying temperature, for example, of about 160.degree. F. at 28. In the alternative, the first drying temperature may be a temperature less than or greater than 160.degree. F. that is suitable for drying clothes while maintaining the integrity of the clothes.

The moisture sensor 24 is provided within the dryer 10 to monitor the amount of moisture in the clothes 14. While the clothes 14 are drying at a first drying temperature, the moisture sensor 24 is detecting the moisture within the clothes 14 at 30. Many different types of sensors and tracking software can be used to carry out this functionality. For example, a sensor 24 is used in conjunction with a monitoring algorithm to track “wet hits”. The “wet hit” occurs when the level of moisture in the clothing 14 is above a predetermined level of moisture. These sensors 24 and techniques for measuring and tracking moisture are so well known that they need not be discussed in further detail herein.

However, the present invention is unique it what the controller 22 does with the information that the clothes 14 have reached a given predetermined threshold level of dryness. If such a “wet hit” is detected by the sensor 24, the temperature of the heat source 20 is maintained at the first drying temperature at 32. If no “wet hits” are detected, meaning the level of moisture in the clothing 14 is below a predetermined level of moisture, the heat level in the heat source 20 is reduced from the first drying temperature down to, a second drying temperature oft for example, about 100.degree. F. at 34. In the alternative, the second drying temperature may be a temperature less than or greater than 100.degree. F. that is suitable for keeping the clothes 14 warm, but not over-dried, when the user returns to retrieve their clothes 14 from the dryer 10.

Generally, when the clothes 14 no longer require the first drying temperature and the desired threshold of dryness is met as detected by the moisture sensor 24, the heat in the heat source 20 is reduced from a first drying temperature to a second drying temperature, which is a temperature lower than the first drying temperature. Thus, the temperature of the heat source 20 is maintained at the lower temperature for the remaining time that has been purchased to reduce the overall energy and cost of drying the clothes 14 in the dryer 10. Once the predetermined time expires, the drying cycle ends, and the heat source 20 and dryer 10 are turned off at 36. At the end of the drying cycle, a user then retrieves the clothes 14 from the clothes dryer 10.

In view of the foregoing, a new and novel method is provided that automatically lowers the first drying temperature, preferably about 160.degree. F., of the heat source 20 for a clothes dryer 10 to a second operating temperature, preferably about 100.degree. F., when the clothes 14 are sufficiently dry. This method of reducing heat conserves energy to operate the dryer 10 and helps avoid over-drying. This method is particularly well-suited for use in coin-operated dryers 10 where large blocks of predetermined time are purchased.

It would be appreciated by those skilled in the art that various changes and modifications can be made to the illustrated embodiments without departing from the spirit of the present invention. All such modifications and changes are intended to be covered by the present invention and appended claims.

1. A method of drying clothing, comprising the steps of:
providing a coin-operated clothes dryer;
providing a heat source in thermal communication with the dryer;
inserting clothes into the dryer;
initiating a drying cycle to run a predetermined period of time;
operating the heat source at a first drying temperature;
sensing moisture in the clothes;
lowering the temperature of the heat source to a second drying temperature when the level of moisture in the clothing is reduced to a predetermined level; and
turning off the heat source and the dryer after the predetermined period of time has elapsed.

2. The method of claim 1, wherein the predetermined period of time was purchased by a user in at least one block of time.

3. The method of claim 1, wherein the first drying temperature is set at a temperature suitable for sufficiently drying clothes while maintaining the integrity of the clothes.

4. The method of claim 1, wherein the second drying temperature is set at a temperature suitable for keeping the clothes warm.
